(19) United States
(12) Patent Application Publication
(10) Pub. No.: US 2014/0242296 A1
(43) Pub. Date: Aug. 28, 2014

(54) METHOD FOR PRODUCING SLURRY FOR HEAT-RESISTANT LAYER FOR LITHIUM ION SECONDARY BATTERY AND METHOD FOR PRODUCING ELECTRODE FOR LITHIUM ION SECONDARY BATTERY

(71) Applicant: ZEON CORPORATION, Tokyo (JP)

(72) Inventor: Mitsunori MOTODA, Yokohama-shi (JP)

(73) Assignee: ZEON CORPORATION, Tokyo (JP)

(21) Appl. No.: 14/190,878

(22) Filed: Feb. 26, 2014

(30) Foreign Application Priority Data
Feb. 27, 2013 (JP) 2013-036720

(51) Int. Cl. H01M 2/16; H01M 4/04; H01M 4/139; H01M 10/42

(52) U.S. Cl. CPC H01M 2/166; H01M 10/4235; H01M 4/0402; H01M 4/139
USPC 427/541; 523/340; 523/322

(57) ABSTRACT

A method for producing a slurry for a heat-resistant layer for a lithium ion secondary battery, including: a step of producing a polymer aqueous dispersion by polymerizing a monomer in an aqueous medium to give a polymer aqueous dispersion containing a polymer with a polymerization conversion rate of 90 to 100%, a step of obtaining a mixed solution by mixing N-methylpyrrolidone and the polymer aqueous dispersion, a step of obtaining a binder composition by removing an unreacted monomer and the aqueous medium from the mixed solution, and a step of obtaining a slurry by dispersing non-conductive microparticles in the binder composition, wherein the step of obtaining the binder composition includes removing the aqueous medium and the unreacted monomer by using a distillation column under a reduced pressure so that the binder composition contains the unreacted monomer and a water content in predetermined amounts.

### CROSS-REFERENCE TO RELATED APPLICATION

The disclosure of the following priority application is herein incorporated by reference:

Japanese Patent Application No. 2013-036720, filed on Feb. 27, 2013.

### TECHNICAL FIELD

The present invention relates to a method for producing a slurry for a heat-resistant layer for a lithium ion secondary battery, which is for forming a heat-resistant layer on the surface of an electrode or separator of a lithium ion secondary battery, and to a method for producing an electrode for a lithium ion secondary battery having a heat-resistant layer formed by using this slurry for a heat-resistant layer.

### BACKGROUND ART

Lithium ion secondary batteries are specifically in heavy usage in small-sized electronics since they show the highest energy density among batteries that are in practical use. Furthermore, expansion into uses in automobiles is also expected, and a higher capacity, a longer lifetime, and further improvement in safeness are demanded.

In a lithium ion secondary battery, an organic separator of a polyolefin such as polyethylene and polypropylene is generally used so as to prevent the short-circuiting between a positive electrode and a negative electrode. Since the organic separator of a polyolefin has a physical property that it melts at 200° C. or less, the temperature of the battery sometimes increases by an internal or external stimulation. When the temperature of the battery increases, the short-circuiting between the positive electrode and negative electrode, the release of electric energy, and the like occur due to the changes in volume such as contraction and melting, and thus it is possible that the performances of the battery are affected.

Therefore, in order to solve such problem, it is suggested to laminate a heat-resistant layer containing a binder and non-conductive microparticles such as inorganic particles on an organic separator or electrode (positive electrode or negative electrode). Meanwhile, when a slurry for a heat-resistant layer for a lithium ion secondary battery for forming the heat-resistant layer contains much water content, the dispersibility of the slurry is deteriorated, whereas when the slurry contains much impurities such as an unreacted monomer, bubbling occurs when the slurry is applied. Therefore, it is required to decrease impurities such as the water content and unreacted monomer in the slurry.

Patent Document 1 and Patent Document 2 describe that, in obtaining a solution of a positive electrode binder (polymer) in N-methyl-2-pyrrolidone (NMP), the amounts of the water content and unreacted monomer are decreased by a water vapor distillation method or by using an evaporator.

### CITATION LIST

### Patent Literature

Patent Document 1: WO 2011/122297 A
Patent Document 2: JP 3710826 B2

### SUMMARY OF INVENTION

### Technical Problem

However, when the method for decreasing the water content and unreacted monomer described in Patent Document 1 and Patent Document 2 is used, it is possible that the loss of the polymer and NMP increases in decreasing the amounts of the impurities such as the water content and unreacted monomer.

The present invention aims at providing a method for producing a slurry for a heat-resistant layer for a lithium ion secondary battery by which a slurry containing a water content and an unreacted monomer in decreased amounts can be efficiently obtained, and a method for producing an electrode for a lithium ion secondary battery having a heat-resistant layer formed by using this slurry for a heat-resistant layer.

### Solution to Problem

The present inventors did intensive studies so as to solve the above-mentioned problem, and consequently found that the above-mentioned object can be achieved by conducting distillation under a reduced pressure by using a distillation column, and completed the present invention.

Namely, the present invention provides the following.

(1) A method for producing a slurry for a heat-resistant layer for a lithium ion secondary battery, including: a step of producing a polymer aqueous dispersion by polymerizing a monomer in an aqueous medium to give a polymer aqueous dispersion containing a polymer with a polymerization conversion rate of 90 to 100%, a step of obtaining a mixed solution by mixing N-methylpyrrolidone and the polymer aqueous dispersion, a step of obtaining a binder composition by removing an unreacted monomer and the aqueous medium from the mixed solution, and a step of obtaining a slurry by dispersing non-conductive microparticles in the binder composition, wherein the step of obtaining the binder composition includes removing the aqueous medium and the unreacted monomer by using a distillation column under a reduced pressure so that the binder composition contains the unreacted monomer in an amount of 300 ppm or less and a water content in an amount of 5,000 ppm or less.

(2) The method for producing a slurry for a heat-resistant layer for a lithium ion secondary battery according to (1), wherein the slurry having a solid content concentration of 10 to 50% is obtained by adding N-methylpyrrolidone, in at least one of (i) during the step of obtaining the binder composition, (ii) between the step of obtaining the binder composition and the step of obtaining the slurry, (iii) during the step of obtaining the slurry, and (iv) after the step of obtaining the slurry.

(3) The method for producing a slurry for a heat-resistant layer for a lithium ion secondary battery according to (1) or (2), wherein the step of obtaining the binder composition includes a step of adding a substance that can be azeotropically distilled with water to the mixed solution.

(4) The method for producing a slurry for a heat-resistant layer for a lithium ion secondary battery according to any one of (1) to (3), wherein the step of obtaining the slurry includes dispersing the non-conductive microparticles by using a dispersing machine having a circumferential velocity of 4 to 60 m/s.

(5) A method for producing an electrode for a lithium ion secondary battery, including a step of applying the slurry for a heat-resistant layer for a lithium ion secondary battery according to any one of (1) to (4), and a step of drying the slurry.

### Advantageous Effects of Invention

According to the present invention, a method for producing a slurry for a heat-resistant layer for a lithium ion secondary battery by which a slurry with decreased amounts of water content and unreacted monomer can be efficiently obtained, and a method for producing an electrode for a lithium ion secondary battery having a heat-resistant layer formed by using this slurry for a heat-resistant layer are provided.

### BRIEF DESCRIPTION OF DRAWINGS

FIG. 1 is a drawing showing the outline of a binder composition production device according to an exemplary embodiment of the present invention.

### DESCRIPTION OF EMBODIMENTS

Hereinafter the method for producing a slurry for a heat-resistant layer for a lithium ion secondary battery according to an exemplary embodiment of the present invention will be explained with referring to the drawing. The method for producing a slurry for a heat-resistant layer for a lithium ion secondary battery according to the present invention includes a step of producing a polymer aqueous dispersion by polymerizing a monomer in an aqueous medium to give a polymer aqueous dispersion containing a polymer with a polymerization conversion rate of 90 to 100%, a step of obtaining a mixed solution by mixing N-methylpyrrolidone and the polymer aqueous dispersion, a step of obtaining a binder composition by removing an unreacted monomer and the aqueous medium from the mixed solution, and a step of obtaining a slurry by dispersing non-conductive microparticles in the binder composition, wherein the step of obtaining the binder composition includes removing the aqueous medium and the unreacted monomer by using a distillation column under a reduced pressure so that the binder composition contains the unreacted monomer in an amount of 300 ppm or less and a water content in an amount of 5,000 ppm or less.

(Step of Producing Polymer Aqueous Dispersion)

In the method for producing a slurry for a heat-resistant layer for a lithium ion secondary battery according to the present invention, a polymer aqueous dispersion is first produced. Although the polymer contained in the polymer aqueous dispersion is not specifically limited as long as it is a compound that can bind non-conductive microparticles mentioned below to each other, polymer compounds such as diene-based polymers and acrylic-based polymers can be used.

(Diene-Based Polymers)

Specific examples of the diene-based polymers may include conjugate diene homopolymers such as polybutadiene and polyisoprene; aromatic vinyl-conjugate diene copolymers such as styrene-butadiene copolymers (SBR) that are optionally carboxy-modified; vinyl cyanide-conjugate diene copolymers such as acrylonitrile-butadiene copolymers (NBR); and the like.

(Acrylic-Based Polymers)

Acrylic-based polymers are homopolymers of (meth)acrylic acid esters, or copolymers thereof with monomers that are copolymerizable with these homopolymers. In the present specification, “(meth)acryl” means “acryl” and “methacryl”.

Examples of the (meth)acrylic acid ester monomers from which the homopolymers or copolymers are derived may include acrylic acid alkyl esters such as methyl acrylate, ethyl acrylate, n-propyl acrylate, isopropyl acrylate, n-butyl acrylate, t-butyl acrylate, pentyl acrylate, hexyl acrylate, heptyl acrylate, octyl acrylate, 2-ethylhexyl acrylate, nonyl acrylate, decyl acrylate, lauryl acrylate, n-tetradecyl acrylate and stearyl acrylate; methacrylic acid alkyl esters such as methyl methacrylate, ethyl methacrylate, n-propyl methacrylate, isopropyl methacrylate, n-butyl methacrylate, t-butyl methacrylate, pentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate and stearyl methacrylate; and the like.

Examples of the monomers that can be copolymerized may include unsaturated carboxylic acids such as acrylic acid, methacrylic acid, itaconic acid and fumaric acid; carboxylic acid esters having two or more carbon-carbon double bonds such as ethylene glycol dimethacrylate, diethylene glycol dimethacrylate and trimethylolpropane triacrylate; styrene-based monomers such as styrene, chlorostyrene, vinyltoluene, t-butylstyrene, vinylbenzoic acid, methylvinylbenzoic acid, vinylnaphthalene, chloromethylstyrene, hydroxymethylstyrene, α-methylstyrene and divinylbenzene; amide-based monomers such as acrylamide, N-methylolacrylamide and acrylamide-2-methylpropanesulfonate; α,β-unsaturated nitrile compounds such as acrylonitrile and metacrylonitrile; olefins such as ethylene and propylene; diene-based monomers such as butadiene and isoprene; halogen atom-containing monomers such as vinyl chloride and vinylidene chloride; vinyl esters such as vinyl acetate, vinyl propionate, vinyl butyrate and vinyl benzoate; vinyl ethers such as methyl vinyl ether, ethyl vinyl ether and butyl vinyl ether; vinylketones such as methyl vinyl ketone, ethyl vinyl ketone, butyl vinyl ketone, hexyl vinyl ketone and isopropenyl vinyl ketone; hetero ring-containing vinyl compounds such as N-vinylpyrrolidone, vinylpyridine and vinylimidazole; hydroxyalkyl group-containing compounds such as β-hydroxyethyl acrylate and β-hydroxyethyl methacrylate; and the like.

Among these, copolymers of acrylonitrile and (meth)acrylic acid esters can be preferably used.

(Other Monomers)

Furthermore, the polymer contained in the polymer aqueous dispersion may further have other monomer units that can be copolymerized with the above-mentioned monomers. Examples of the other monomers that can be copolymerized with the above-mentioned monomers may include monomers having a crosslinkable group (hereinafter sometimes described as “crosslinkable group-containing monomers”), carboxylic acid ester monomers having two or more carbon-carbon double bonds, halogen atom-containing monomers, vinyl ester monomers, vinyl ether monomers, vinyl ketone monomers, hetero ring-containing vinyl monomers, acrylamide, methacrylamide and the like.

Examples of the crosslinkable group-containing monomers may include monofunctional monomers having one olefinic double bond having a thermal-crosslinkable crosslinkable group, and multifunctional monomers having at least two olefinic double bonds.

Examples of the thermal-crosslinkable crosslinkable group contained in the monofunctional monomers having one olefinic double bond may include monomers containing at least one kind selected from the group consisting of an epoxy group, a N-methylolamide group, an oxetanyl group and an oxazoline group. Among these, monomers containing an epoxy group are more preferable since the crosslinking and crosslinking density are easily adjusted.

Examples of the monomers containing an epoxy group may include monomers having a carbon-carbon double bond and an epoxy group, and monomers containing a halogen atom and an epoxy group.

Examples of the monomers having a carbon-carbon double bond and an epoxy group may include unsaturated glycidyl ethers such as vinyl glycidyl ether, allyl glycidyl ether, butenyl glycidyl ether and o-allylphenyl glycidyl ether; monoepoxides of dienes or polyenes such as butadiene monoepoxide, chloroprene monoepoxide, 4,5-epoxy-2-pentene, 3,4-epoxy-1-vinylcyclohexene and 2-epoxy-5,9-cyclododecadiene; alkenyl epoxides such as 3,4-epoxy-1-butene and 1,2-epoxy-2-epoxy-9-decene; glycidyl esters of unsaturated carboxylic acids such as glycidyl acrylate, glycidyl methacrylate, glycidyl crotonate, glycidyl-4-heptenoate, glycidyl sorbate, glycidyl linoleate, glycidyl-4-methyl-3-pentenoate, glycidyl ester of 3-cyclohexenecarboxylic acid and glycidyl ester of 4-methyl-3-cyclohexenecarboxylic acid; and the like.

Examples of the monomers containing a halogen atom and an epoxy group may include epihalohydrins such as epichlorohydrin, epibromohydrin, epiiodohydrin, epifluorohydrin and β-methylepichlorohydrin; chlorostyrene oxide; and dibromophenylglycidyl ether.

Examples of the monomer containing a N-methylolamide group may include (meth)acrylamides having a methylol group such as N-methylol (meth)acrylamide.

Examples of the monomers having an oxetanyl group may include 3-((meta)acryloyloxymethyl)oxetane, 3-((meta)acryloyloxymethyl)-2-trifluoromethyloxetane, 3-((meta)acryloyloxymethyl)-2-phenyloxetane, 2-((meta)acryloyloxymethyl)oxetane, 2-((meta)acryloyloxymethyl)-4-trifluoromethyloxetane and the like.

Examples of the monomers having an oxazoline group may include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, 2-isopropenyl-5-ethyl-2-oxazoline and the like.

Examples of the multifunctional monomers having at least two olefinic double bonds may include allyl acrylate or allyl methacrylate, ethylene diacrylate, ethylene dimethacrylate, trimethylolpropane-triacrylate, trimethylolpropane-methacrylate, dipropylene glycol diallyl ether, polyglycol diallyl ether, triethylene glycol divinyl ether, hydroquinone diallyl ether, tetraallyloxyethane, or other allyl or vinyl ethers of multifunctional alcohols, tetraethylene glycol diacrylate, triallylamine, trimethylolpropane-diallyl ether, methylenebisacrylamide and/or divinylbenzene.

Examples of the carboxylic acid ester monomers having two or more carbon-carbon double bonds may include ethylene glycol dimethacrylate, diethylene glycol dimethacrylate and trimethylolpropane triacrylate.

Examples of the halogen atom-containing monomers may include vinyl chloride and vinylidene chloride.

Examples of the vinyl ester monomers may include vinyl acetate, vinyl propionate and vinyl butyrate.

Examples of the vinyl ether monomers may include methyl vinyl ether, ethyl vinyl ether and butyl vinyl ether.

Examples of the vinyl ketone monomers may include methyl vinyl ketone, ethyl vinyl ketone, butyl vinyl ketone, hexyl vinyl ketone and isopropenyl vinyl ketone.

Examples of the hetero ring-containing vinyl monomers may include N-vinylpyrrolidone, vinylpyridine, vinylimidazole and the like.

(Method for Producing Polymer Aqueous Dispersion)

The polymer aqueous dispersion is produced by, for example, polymerizing a monomer composition containing the monomer in an aqueous medium. The polymerization method is not specifically limited, and any of methods such as a solution polymerization method, a suspension polymerization method, a bulk polymerization method and an emulsification polymerization method can be used. Examples of the polymerization reaction may include ion polymerization, radical polymerization, living radical polymerization and the like. Among these, an emulsification polymerization method is the most preferable from the viewpoints of production efficiency, for example, a polymer is directly obtained in a state that the polymer is dispersed in water, and thus a treatment for dispersion is not necessary.

As used herein, the aqueous medium is a medium containing water, and specific examples may include water, ketones, alcohols, glycols, glycol ethers, ethers and mixtures thereof.

The emulsification polymerization method is a conventional method such as the method described in “Course of Experimental Chemistry”, Vol. 28, (published by Maruzen Co. Ltd., edited by The Chemical Society of Japan), specifically, a method including adding water, a dispersing agent, an emulsifier, additives such as a crosslinking agent, an initiator and a monomer to an airtight container equipped with a stirrer and a heating apparatus so as to give a predetermined composition, stirring them to thereby emulsify the monomer and the like in the water, and raising the temperature under stirring to thereby initiate polymerization. Alternatively, it is a method including emulsifying the composition and thereafter putting the emulsion into an airtight container, and initiating a reaction in a similar manner.

The emulsifier, dispersing agent, polymerization initiator and the like are those generally used in these polymerization methods, and the use amounts thereof may be amounts that are generally used. Furthermore, it is also possible to adopt seed particles in the polymerization (seed polymerization).

Furthermore, although the polymerization temperature and polymerization time can be optionally selected depending on the technique of the emulsification polymerization, the kind of the polymerization initiator used, and the like, the polymerization temperature is generally about 30° C. or more, and the polymerization time is generally about 0.5 to 30 hours.

Furthermore, the polymerization conversion rate in the obtained polymer aqueous dispersion is preferably 90 to 100%. When the polymerization conversion rate is too small, the unreacted monomer is present much in the polymer aqueous dispersion, and thus it is difficult to remove the unreacted monomer. Furthermore, when the polymerization conversion rate is too small, the obtained polymer cannot have a sufficient strength.

(Step of Obtaining Mixed Solution)

In the method for producing a slurry for a heat-resistant layer for a lithium ion secondary battery according to the present invention, a mixed solution is obtained by mixing the polymer aqueous dispersion obtained in the step of producing the polymer aqueous dispersion and N-methylpyrrolidone (hereinafter also referred to as “NMP”).

Although the method for mixing the polymer aqueous dispersion and NMP is not specifically limited, it is preferable to add the polymer aqueous dispersion to the NMP, and it is more preferable to add the polymer aqueous dispersion to the NMP while stirring the NMP at 30 to 70° C., from the viewpoint that the polymer aqueous dispersion is homogeneously dissolved in the NMP and thus a flocculate is difficult to be formed.

Furthermore, in the step of obtaining the mixed solution, the amount of the NMP used is preferably 6/1 to 20/1, more preferably 9/1 to 18/1, further preferably 11/1 to 16/1 by a weight ratio to the polymer (solid content) contained in the polymer aqueous dispersion (weight of NMP/weight of polymer). When the amount of the NMP used is too much, the distillation efficiency in the step of obtaining the binder composition mentioned below decreases due to the dilution by the NMP. Furthermore, when the amount of the NMP used is too small, the polymer aqueous dispersion cannot be dissolved.

(Step of Obtaining Binder Composition)

In the method for producing a slurry for a heat-resistant layer for a lithium ion secondary battery according to the present invention, a binder composition is obtained by removing the unreacted monomer and aqueous medium from the mixed solution.

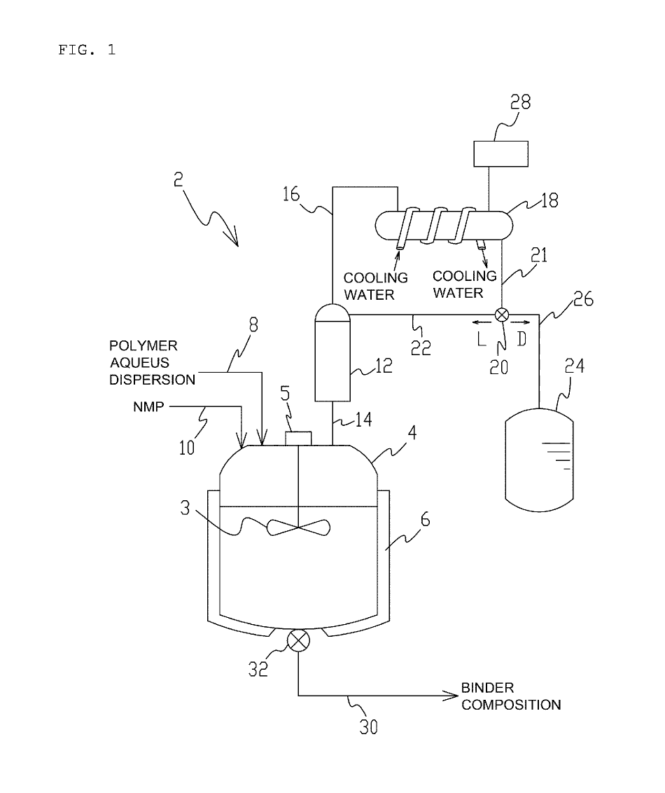

In the step of obtaining the binder composition, a binder composition production device shown in FIG. 1 is used. As shown in FIG. 1, the binder composition production device 2 includes a substitution tank 4 having a stirring blade 3 and a stirrer 5, a heating jacket 6 that is configured to heat the substitution tank 4, a polymer aqueous dispersion-introduction line 8 that is configured to introduce a polymer aqueous dispersion into the substitution tank 4, an NMP introduction line 10 that is configured to introduce NMP into the substitution tank 4, a distillation column 12, a raw material introduction line 14 that is configured to introduce vapor generated by the heating of the mixed solution in the substitution tank 4 into the distillation column 12 and reflux the descent component in the distillation column 12 into the substitution tank 4, a vapor introduction line 16 that is configured to introduce the vapor in the distillation column 12 into a condenser 18, the condenser 18 that is configured to liquefy the vapor introduced from the distillation column 12 by cooling with cooling water, a partition valve 20 that is configured to partition the liquid cooled by the condenser 18 into a reflux liquid and a distilled liquid, a partition line 21 that is configured to introduce the liquid cooled by the condenser 18 into the partition valve 20, a reflux line 22 that is configured to reflux the reflux liquid partitioned by the partition valve 20 into the distillation column 12, a receiver 24 that is configured to collect the distilled liquid partitioned by the partition valve 20, and a distillation line 26 that is configured to introduce the distilled liquid into the receiver 24. Furthermore, in the binder composition production device 2, the system including at least the substitution tank 4, the distillation column 12, the raw material introduction line 14, the vapor introduction line 16, the flow path at the process liquid side of the condenser 18, the partition valve 20 and the reflux line 22 is configured to allow reduction of the pressure by a compressor 28. Furthermore, a binder composition feeding line 30 for feeding the obtained binder composition outside is disposed on the bottom of the substitution tank 4, and a valve 32 is closed in the step of obtaining the binder composition. In addition, in the case when the step of obtaining the mixed solution by using the binder composition production device 2, the valve 32 is closed also in the step of obtaining the mixed solution.

As the distillation column 12, a plate column, a packed column or the like can be used, and a packed column is preferable. Furthermore, a packing material in the case when a packed column is used may be either a regular packing material or an irregular packing material. Furthermore, the distillation column 12 has a number of theoretical stages of preferably 1 to 20, more preferably 1 to 15, and further preferably 2 to 8. When the number of theoretical stages of the distillation column 12 is too high, the time required for the start-up in conducting the distillation becomes long. When the number of theoretical stages of the distillation column 12 is too small, the NMP cannot be separated from the water and unreacted monomer, and thus the loss of the NMP increases.

In conducting the distillation in the step of obtaining the binder composition, at first, the pressure in the system that is constituted to allow pressure reduction by the compressor 28 is decreased to a predetermined pressure. The pressure in the system in decreasing the pressure by the compressor 28 is preferably atmospheric pressure to 20 torr, more preferably atmospheric pressure to 30 torr, further preferably atmospheric pressure to 50 torr, from the initiation of the distillation to a predetermined time such as a period during which a low-boiling point component is present. When the pressure in the above-mentioned system is too high, it is necessary to raise the temperature of the heating by the heating jacket 6 so as to remove the water content from the mixed solution. When the pressure in the above-mentioned system is too low, the distillation velocity increases, and thus it is possible that bubbling occurs due to the unreacted monomer and water remaining in the mixed solution. In this period, from the viewpoint of removal of the water from the mixed solvent, it is preferable to gradually reduce the pressure, for example, to adjust the pressure to about 200 torr at the initiation of the distillation and to about 50 torr at the time when the water content amount in the mixed solvent has become about 5%.

Furthermore, in the case when the distillation has proceeded, for example, when the water content amount in the mixed solution has become 5% or less, the pressure in the above-mentioned system is 150 to 2 torr, more preferably 100 to 2 torr. When the pressure in the above-mentioned system is too high, it is necessary to raise the temperature of the heating by the heating jacket 6 so as to remove the water content from the mixed solution. When the pressure in the system is too low, the water content contained in the mixed solution cannot be sufficiently removed. Furthermore, it is preferable to gradually decrease the pressure in the system in accordance with the progress of the distillation, for example, to decrease the pressure from 100 torr to about 10 torr as the distillation proceeds.

Furthermore, the mixed solution in the substitution tank 4 is heated to a predetermined temperature by the heating jacket 6, and the mixed solution is stirred by the stirring blade 3. The heating jacket 6 heats the mixed solution in the substitution tank 4 to preferably 40 to 130° C., more preferably 50 to 120° C., further preferably to 60 to 110° C. When the temperature in the mixed solution is too high, it is possible that the polymer is deteriorated by heat. Alternatively, when temperature in the mixed solution is too low, vapor cannot be condensed by the condenser 18.

When vapor evolves from the mixed solution in the substitution tank 4, the evolved vapor is introduced into the condenser 18 through the raw material introduction line 14, distillation column 12 and vapor introduction line 16, and cooled by the condenser 18. Meanwhile, NMP has a boiling point of 202° C. and water has a boiling point of 100° C. at an ordinary pressure, and the boiling point of NMP is higher than the boiling point of water also under a reduced pressure. Furthermore, the boiling point of the monomer used in the above-mentioned polymerization of the monomer at an ordinary pressure differs depending on the kind and is less than the boiling point of NMP, and the same applies to the boiling point under a reduced pressure. Therefore, the main components of the vapor that evolves from the mixed solution in the substitution tank 4 are water and the unreacted monomer, and the main components of the liquid cooled by the condenser 18 are water and the unreacted monomer.

The liquid cooled by the condenser 18 is partitioned by the partition valve 20 into a reflux liquid and a distilled liquid according to a reflux ratio R. The partition valve 20 used herein is configured to allow changes in a reflux liquid amount L and a distilled liquid amount D, and the ratio of the reflux liquid amount L and the distilled liquid amount D is represented by a reflux ratio R=L/D. In the step of obtaining the binder, the reflux ratio is preferably 0.3 to 10, more preferably 0.5 to 5, further preferably 1 to 3. When the reflux ratio is too large, the NMP cannot be separated from the water and unreacted monomer, and thus the loss of the NMP increases. When the reflux ratio is too small, the time required for the start-up in conducting the distillation becomes long. The reflux ratio may be a constant value during the distillation (the step of obtaining the binder composition), or may be variable during the distillation (the step of obtaining the binder composition), and in the case when the reflux ratio is variable, the reflux ratio is an average value. Furthermore, in the case when the reflux ratio is variable, it is preferable to adjust the reflux ratio to be large, for example, 1, at the initial stage of the distillation (the step of obtaining the binder composition), and to decrease the reflux ratio as the distillation proceeds.

The distilled liquid is introduced into the receiver 24 through the distillation line 26. The water and unreacted monomer are collected in the receiver 24. Furthermore, the refluxed liquid is introduced into the substitution tank 4 through the reflux line 22, distillation column 12 and raw material introduction line 14.

By conducting the distillation for a predetermined time in such way, the water and unreacted monomer contained in the mixed solution are collected in the receiver 24, and thus the amounts of the water content and unreacted monomer in the mixed solution in the substitution tank 4 are decreased.

The binder composition can be obtained by conducting the distillation until the amount of the unreacted monomer in the substitution tank 4 becomes 300 ppm or less, preferably 50 ppm or less, more preferably 20 ppm or less, and the amount of the water content in the solution in the substitution tank 4 becomes 5,000 ppm or less, preferably 3,000 ppm or less, more preferably 1500 ppm or less, to thereby adjust the amounts of the unreacted monomer and water content to these ranges.

When the amount of the unreacted monomer in the binder composition is too much, unevenness easily occurs on a coating during the application of the slurry for a heat-resistant layer for a lithium ion secondary battery. When the amount of the water content in the binder composition is too much, the slurry bubbles during the application of the slurry for a heat-resistant layer for a lithium ion secondary battery, and thus pinholes are generated on the heat-resistant layer.

Furthermore, in the step of obtaining the binder composition, a substance that can be azeotropically distilled with water may be added to the mixed solution collected in the substitution tank 4, from the viewpoint that the amounts of the water content and unreacted monomer in the binder composition are decreased. Although the substance that can be azeotropically distilled with water is not specifically limited, toluene, acetone, xylene, benzene, ethanol, methanol, isopropyl alcohol, methyl ethyl ketone, and the like can be preferably used, and ethanol can be more preferably used.

The addition amount of the substance that can be azeotropically distilled with water to the mixed solution is preferably 0.01 to 10 parts by weight, more preferably 0.1 to 5 parts by weight, with respect to 100 parts by weight of the amount of the water content contained in the mixed solution. When the addition amount of the substance that can be azeotropically distilled with water is too much, the substance that can be azeotropically distilled with water remains in the obtained binder composition. Alternatively, when the addition amount of the substance that can be azeotropically distilled with water is too small, the effect of azeotropic distillation cannot be obtained.

The timing to add the substance that can be azeotropically distilled with water is the timepoint when the distilled liquid in an amount of preferably 85 to 95%, more preferably about 90% of the amount of the water content included in the polymer aqueous dispersion used in obtaining the mixed solution, i.e., the amount of the water content that was contained in the mixed solution at the initiation of the distillation, has been collected in the receiver 24.

Where necessary, NMP can further be added to the binder composition. Although the timing to add NMP as necessary is not specifically limited, NMP can further be added to the solution in the substitution tank 4 through the NMP introduction line 10 during the step of obtaining the binder composition and/or after the step of obtaining the binder composition.

(Step of Obtaining Slurry)

In the method for producing a slurry for a heat-resistant layer for a lithium ion secondary battery according to the present invention, non-conductive microparticles are dispersed in the binder composition obtained in the step of obtaining the binder composition to give a slurry.

(Non-Conductive Microparticles)

The material that constitutes the non-conductive microparticles is desired to stably exist under an environment in which a lithium ion secondary battery is used and to be electrochemically stable. For example, various non-conductive inorganic microparticles and organic microparticles can be used.

The material for the inorganic microparticles is preferably a material that is electrochemically stable and suitable for preparing a slurry by mixing with other materials such as a viscosity adjusting agent mentioned below. From such viewpoint, as the inorganic microparticles, oxides such as aluminum oxide (alumina), hydrates of aluminum oxide (Boehmite (AlOOH), gibbsite (Al(OH)₃), Bakelite, magnesium oxide, magnesium hydroxide, iron oxide, silicon oxide, titanium oxide (titania) and calcium oxide, nitrides such as aluminum nitrides and silicon nitride, silica, barium sulfate, barium fluoride, calcium fluoride, and the like are used. Among these, alumina is preferable from the viewpoint that it is excellent in heat resistance (for example, resistance against high temperatures of 180° C. or more).

As the organic microparticles, particles of a polymer (polymer) are generally used. In the organic microparticles, the affinity to water can be controlled, thus the amount of the water content contained in the heat-resistant layer in the present invention can be controlled, by adjusting the kind and amount of the functional group on the surfaces thereof. Preferable examples of the organic material for the non-conductive microparticles may include various polymer compounds such as polystyrene, polyethylene, polyimide, melamine resins and phenol resins, and the like. The above-mentioned polymer compound that forms the organic microparticles may be either a homopolymer or a copolymer, and in the case of a copolymer, either of a block copolymer, a random copolymer, a graft copolymer and an alternating copolymer can be used. Furthermore, the polymer compound may be at least partially modified, or may be a crosslinked form. Furthermore, the polymer compound may be a mixture of these polymers. Examples of the crosslinking agent in the case of a crosslinked form may include crosslinked forms each having an aromatic ring such as divinylbenzene, multifunctional acrylate crosslinked forms such as ethylene glycol dimethacrylate, crosslinked forms each having an epoxy group such as glycidyl acrylate and glycidyl methacrylate, and the like.

Where necessary, the non-conductive microparticles may be subjected to elemental substitution, a surface treatment, a solution treatment or the like. Furthermore, the non-conductive microparticles may be such that one of the above-mentioned materials is contained alone or two or more materials are contained in combination at an arbitrary ratio in one particle. Furthermore, the non-conductive microparticles may be used by combining two more kinds of microparticles formed of different materials.

In the step of obtaining a slurry, the amount of the non-conductive microparticles used is preferably 0.1 to 20 parts by weight, more preferably 0.2 to 15 parts by weight, with respect to 100 parts by weight of the polymer contained in the binder composition. When the amount of the non-conductive microparticles is too much, the ion conductivity of the heat-resistant layer is lowered. When the amount of the non-conductive microparticles is too small, the adhesion between the heat-resistant layer and separator is lowered.

(Optional Components)

The slurry may further contain optional components besides the above-mentioned components. Such optional components may include components such as a dispersing agent, a leveling agent, an antioxidant, a polymer other than the above-mentioned polymers, a thickening agent, a defoaming agent and an electrolyte solution additive having a function such as suppression of the decomposition of an electrolyte solution. These are not specifically limited as long as they do not affect the battery reaction.

Examples of the dispersing agent include anionic compounds, cationic compounds, nonionic compounds and polymer compounds. The dispersing agent is selected depending on the non-conductive microparticles used.

Examples of the leveling agent may include surfactants such as alkyl-based surfactants, silicone-based surfactants, fluorine-based surfactants and metal-based surfactants. By incorporating the surfactant, repelling that occurs in applying the slurry onto a predetermined substrate is prevented, and thus the smoothness of the electrode can be improved.

Examples of the antioxidant may include phenol compounds, hydroquinone compounds, organic phosphorus compounds, sulfur compounds, phenylenediamine compounds, polymer type phenol compounds and the like. The polymer type phenol compounds are polymers having phenolic structures in the molecule, and polymer type phenol compounds having a weight average molecular weight of preferably 200 to 1,000, more preferably 600 to 700 are further preferably used.

As the polymers other than the above-mentioned polymers, polytetrafluoroethylene (PTFE), polyvinylidene fluoride (PVDF), polyacrylic acid derivatives, polyacrylonitrile derivatives, soft polymers and the like can be used.

Examples of the thickening agents may include cellulose-based polymers such as carboxymethyl cellulose, methyl cellulose and hydroxypropyl cellulose, and ammonium salts and alkali metal salts thereof; (modified) poly(meta)acrylic acid, and ammonium salts and alkali metal salts thereof; polyvinyl alcohols such as copolymers of (modified) polyvinyl alcohol, acrylic acid or acrylic acid salt with vinyl alcohol, and copolymers of maleic anhydride or maleic acid or fumaric acid with vinyl alcohol; polyethylene glycol, polyethylene oxide, polyvinyl pyrrolidone, modified polyacrylic acids, oxidized starch, phosphate starch, casein, various modified starches, acrylonitrile-butadiene copolymer hydrides, and the like. In the present specification, the “(modified) poly” means “unmodified poly” or “modified poly”.

As the defoaming agent, metal soaps, polysiloxanes, polyethers, higher alcohols, perfluoroalkyls and the like are used.

As the additive for an electrolyte solution, vinylene carbonate, which is used in a mixed slurry mentioned below and an electrolyte solution, and the like can be used. By incorporating the additive for an electrolyte solution, the battery has an excellent cycle lifetime.

(Method for Producing Slurry)

In the method for producing a slurry for a heat-resistant layer for a lithium ion secondary battery according to the present invention, a slurry is obtained by dispersing the non-conductive microparticles in the binder composition obtained as above. Furthermore, in the step of obtaining a slurry, where necessary, NMP and optional components may be added besides the non-conductive microparticles and binder composition.

The binder composition used in the step of obtaining a slurry is fed, for example, through the binder composition feeding line 30 by opening the valve 32 of the substitution tank 4 in the binder composition production device 2 shown in FIG. 1.

In the step of obtaining a slurry, the method for dispersing the non-conductive microparticles in the binder composition is not specifically limited. By using the non-conductive microparticles, the binder composition, and NMP and optional components that are added as necessary, a slurry in which the non-conductive microparticles are highly dispersed can be obtained irrespective of the method for dispersing and the order of addition. As a device used for dispersing the non-conductive microparticles in the binder composition, for example, mixing apparatuses of a stirring type, a shaking type and a rotary type, and the like can be used. Alternatively, dispersion kneader devices such as a corn mill, a colloid mill, a homogenizer, a ball mill, a sand mill, a roll mill, a planetary mixer and a planetary kneader can also be used. In using the mixing device and dispersion kneader device, in the case when a circumferential velocity can be defined, the circumferential velocity is preferably 4 to 50 m/s, more preferably 5 to 50 m/s, further preferably 10 to 40 m/s. When the circumferential velocity is too fast, the bubbling of the slurry and the pulverization of the non-conductive microparticles occur. When the circumferential velocity is too slow, the dispersibility of the non-conductive microparticles in the slurry is deteriorated.

Furthermore, in the step of obtaining a slurry in the above-mentioned way, NMP may be added as necessary, and the timing to add NMP is not specifically limited, and NMP may further be added to the slurry in the step of obtaining the slurry and/or after the step of obtaining the slurry.

The slurry for a heat-resistant layer for a lithium ion secondary battery according to the present invention (hereinafter sometimes referred to as “slurry for a heat-resistant layer”) has a solid content concentration of preferably 10 to 60%, more preferably 20 to 50%, further preferably 30 to 40%. When the solid content concentration of the slurry for a heat-resistant layer is too high, the slurry has a high viscosity, and thus the film thickness of the heat-resistant layer cannot be controlled. When the solid content concentration of the slurry for a heat-resistant layer is too low, the volume of the slurry for a heat-resistant layer increases, and thus a tank for containing the slurry for a heat-resistant layer has a large size. Furthermore, when the solid content concentration of the slurry for a heat-resistant layer is too low, it becomes difficult to apply the slurry for a heat-resistant layer in forming a heat-resistant layer.

(Method for Producing Heat-Resistant Layer)

The heat-resistant layer can be obtained by forming the above-mentioned slurry for a heat-resistant layer for a lithium ion secondary battery in the form of a film, and drying the slurry.

The heat-resistant layer may be used by laminating it on an organic separator or an electrode, or as a separator itself. Furthermore, the heat-resistant layer formed by the slurry for a heat-resistant layer can be used by laminating it on an electrode.

As the method for producing the heat-resistant layer for a lithium ion secondary battery, (I) a method including applying the slurry for a heat-resistant layer on a predetermined substrate (positive electrode, negative electrode or organic separator), and then drying the slurry, (II) a method including immersing a substrate (positive electrode, negative electrode or organic separator) in the slurry for a heat-resistant layer, and drying the substrate, and (III) a method including applying the slurry for a heat-resistant layer onto a peeling film to form a film, and transferring the obtained heat-resistant layer onto a predetermined substrate (positive electrode, negative electrode or organic separator). Among these, (I) the method including applying the slurry for a heat-resistant layer on a predetermined substrate (positive electrode, negative electrode or organic separator), and then drying the slurry is the most preferable since the film thickness of the heat-resistant layer is easily controlled.

The specific production methods of the above-mentioned (I) to (III) will be explained below.

In the method of (I), the heat-resistant layer is formed by applying the slurry for a heat-resistant layer onto a predetermined substrate (positive electrode, negative electrode or organic separator), and drying the slurry.

The method for applying the slurry for a heat-resistant layer onto the substrate is not specifically limited, and examples may include methods such as a doctor blade method, a reverse roll method, a direct roll method, a gravure method, an extrusion method and a brush application method.

Examples of the drying method may include drying methods such as drying by warm air, hot air or low humidity air, vacuum drying, and drying methods by the irradiation of (far) infrared ray, electron beam and the like. The drying temperature can be changed depending on the kind of a dispersion medium to be used. In order to completely remove the solvent (NMP), it is preferable to dry by a fan drier. The drying temperature is preferably 70 to 200° C., more preferably 90 to 120° C. When the drying temperature is too high, it is possible that the polymer is deteriorated. When the drying temperature is too low, the drying takes a long time.

In the method of (II), the heat-resistant layer is formed by immersing a substrate (positive electrode, negative electrode or organic separator) in the slurry for a heat-resistant layer, and drying the substrate. The method for immersing the substrate in the slurry for a heat-resistant layer is not specifically limited, and for example, the substrate can be immersed by dip coating in a dip coater or the like.

As the drying method, the same methods as the drying method in the method of the above-mentioned (I) may be exemplified.

In the method of (III), a heat-resistant layer formed on a peeling film is produced by applying the slurry for a heat-resistant layer onto a peeling film and forming the slurry into a film. Subsequently, the obtained heat-resistant layer is transferred onto a substrate (positive electrode, negative electrode or organic separator).

As the application method, the same methods as the application methods in the method of the above-mentioned (I) may be exemplified. The transfer method is not specifically limited.

The heat-resistant layer obtained by any of the methods of (I) to (III) can be subjected to a pressurization treatment as necessary by using a mold press, a roll press or the like to thereby improve the adhesion between the substrate (positive electrode, negative electrode or organic separator) and the heat-resistant layer. However, when the pressurization treatment is excessively conducted at this time, the porosity of the heat-resistant layer may be deteriorated, and thus the pressure and pressurization time are suitably controlled.

The heat-resistant layer has a film thickness of, preferably 0.1 to 20 μm, more preferably 0.2 to 15 μm, further preferably 0.3 to 10 μm. When the film thickness of the heat-resistant layer is too thick, the ion conductivity is lowered. Furthermore, when the film thickness of the heat-resistant layer is too thin, the heat resistance is lowered.

The heat-resistant layer is formed on the surface of the substrate (positive electrode, negative electrode or organic separator), and may be formed on the surface of any of the positive electrode, negative electrode or organic separator, or may be formed on all of the positive electrode, negative electrode and organic separator.

(Lithium Ion Secondary Battery)

The lithium ion secondary battery including the heat-resistant layer formed by using the slurry for a heat-resistant layer of a lithium ion secondary battery according to the present invention includes a positive electrode, a negative electrode, a separator and an electrolyte solution, and includes at least one of a positive electrode having the heat-resistant layer formed thereon, a negative electrode having the heat-resistant layer formed thereon and an organic separator having the heat-resistant layer formed thereon.

(Electrodes)

The positive electrode and negative electrode are generally formed by attaching an electrode active material layer containing an electrode active material as an essential component to a current collector.

(Electrode Active Material)

The electrode active material used for the electrodes for a lithium ion secondary battery may be any one as long as lithium ion can be reversibly inserted or released by applying a potential in an electrolyte, and either an inorganic compound or an organic compound can be used.

The electrode active materials (positive electrode active materials) for a positive electrode of a lithium ion secondary battery are roughly classified into those formed of inorganic compounds and those formed of organic compounds. Examples of the positive electrode active materials formed of inorganic compounds may include transition metal oxides, composite oxides of lithium and transition metals, transition metal sulfides and the like. As the above-mentioned transition metals, Fe, Co, Ni, Mn and the like are used. Specific examples of the inorganic compounds used in the positive electrode active material may include lithium-containing composite metal oxides such as LiCoO₂, LiNiO₂, LiMn₂O₄, LiFePO₄ and LiFeVO₄; transition metal sulfides such as TiS₂, TiS₃ and amorphous MoS₂; transition metal oxides such as Cu₂V₂O₃, amorphous V₂O—P₂O₅, MoO₃, V₂O₅ and V₆O₁₃. These compounds may be partially element-substituted. As the positive electrode active material formed of an organic compound, conductive polymers such as polyacetylene and poly p-phenylene can also be used. Iron-based oxides, which have poor electrical conductivity, may be used as electrode active materials coated with a carbon material, by allowing the presence of a carbon source substance during reduction calcination. Furthermore, these compounds may be partially element-substituted.

The positive electrode active material for a lithium ion secondary battery may be a mixture of the above-mentioned inorganic compound and organic compound. Although the particle diameter of the positive electrode active material is suitably selected with the other constitutional requirements of the battery in mind, the volume average particle diameter D50 is preferably 0.1 to 50 μm, more preferably 1 to 20 μm, from the viewpoint that the battery characteristics such as loading characteristic and cycle characteristic are improved, and from the viewpoint that a secondary battery having a large charge-discharge capacity can be obtained and the handling in the production of the slurry for an electrode and the electrode is easy. The volume average particle diameter D50 of the positive electrode active material can be obtained by measuring the particle diameter of the positive electrode active material by using a laser diffraction particle size distribution analyzer.

Examples of the electrode active material for a negative electrode of a lithium ion secondary battery (negative electrode active material) may include carbonaceous materials such as amorphous carbon, graphite, natural graphite, mesocarbon microbeads and pitch-based carbon fibers, conductive polymers such as polyacene, and the like. Furthermore, as the negative electrode active material, metals such as silicon, tin, zinc, manganese, iron and nickel and alloys thereof, and oxides and sulfates of the metals or alloys are used. In addition, metal lithium, lithium alloys such as Li—Al, Li—Bi—Cd and Li—Sn—Cd, lithium transition metal nitrides, silicones and the like can be used. As the electrode active material, an electrode active material formed by attaching a conductivity-imparting material to the surface thereof by a mechanical modification method can also be used. Although the particle diameter of the negative electrode active material is suitably selected with the other constitutional requirements of a battery in mind, the volume average particle diameter D50 of the negative electrode active material is preferably 1 to 50 μm, more preferably 15 to 30 μm, from the viewpoint of improvement of the battery characteristics such as initial efficiency, loading characteristic and cycle characteristic. The volume average particle diameter D50 of the negative electrode active material is measured by a similar method to that for the positive electrode active material.

(Binder for Active Material)

In the present invention, it is preferable that the electrode active material layer contains a binder for an active material layer besides the electrode active material. By incorporating the binder for an active material layer, the binding property of the electrode active material layer in the electrode is improved, the strength against mechanical forces that are applied in the steps such as rolling-up of the electrode is increased, and the electrode active material layer in the electrode becomes difficult to be detached, and thus the risk of short-circuiting by the detached substance is decreased.

As the binder for an active material layer, various resin components can be used. For example, polyethylene, polytetrafluoroethylene (PTFE), polyvinylidene fluoride (PVDF), tetrafluoroethylene-hexafluoropropylene copolymer (FEP), polyacrylic acid derivatives, polyacrylonitrile derivatives and the like can be used. These may be used alone or by combining two or more kinds.

Furthermore, the soft polymers exemplified below can also be used as the binder for an active material layer.

Examples may include acrylic-based soft polymers that are homopolymers of acrylic acid or methacrylic acid derivatives, or copolymers with monomers that can be copolymerized with the homopolymers, such as polybutyl acrylate, polybutyl methacrylate, polyhydroxyethyl methacrylate, polyacrylamide, polyacrylonitrile, butyl acrylate-styrene copolymers, butyl acrylate-acrylonitrile copolymers and butyl acrylate-acrylonitrile-glycidyl methacrylate copolymers; isobutylene-based soft polymers such as polyisobutylene, isobutylene-isoprene rubber and isobutylene-styrene copolymers; diene-based soft polymers such as polybutadiene, polyisoprene, butadiene-styrene random copolymers, isoprene-styrene random copolymers, acrylonitrile-butadiene copolymers, acrylonitrile-butadiene-styrene copolymers, butadiene-styrene-block copolymers, styrene-butadiene-styrene-block copolymers, isoprene-styrene-block copolymers and styrene-isoprene-styrene-block copolymers; silicon-containing soft polymers such as dimethylpolysiloxane, diphenylpolysiloxane and dihydroxypolysiloxane; olefin-based soft polymers such as liquid polyethylene, polypropylene, poly-1-butene, ethylene-α-olefin copolymers, propylene-α-olefin copolymers, ethylene-propylene-diene copolymers (EPDM) and ethylene-propylene-styrene copolymers; vinyl-based soft polymers such as polyvinyl alcohol, polyvinyl acetate, polyvinyl stearate and vinyl acetate-styrene copolymers; epoxy-based soft polymers such as polyethylene oxide, polypropylene oxide and epichlorohydrin rubbers; fluorine-containing soft polymers such as vinylidene fluoride-based rubbers and tetrafluoroethylene-propylene rubbers; other soft polymers such as natural rubbers, polypeptides, proteins, polyester-based thermoplastic elastomers, vinyl chloride-based thermoplastic elastomers and polyamide-based thermoplastic elastomers; and the like. These soft polymers may be those having a crosslinked structure, or those having a functional group introduced therein by modification.

The amount of the binder for an active material layer in the electrode active material layer is generally 0.1 to 5 parts by weight, preferably 0.2 to 4 parts by weight, more preferably 0.5 to 3 parts by weight with respect to 100 parts by weight of the electrode active material, from the viewpoint of prevention of the dropoff of the active material from the electrode without inhibiting the battery reaction.

The binder for an active material layer is prepared as a solution or a dispersion liquid so as to prepare an electrode. The viscosity at this time is in the range of, generally 1 to 300,000 mPa·s, preferably 50 to 10,000 mPa·s. The above-mentioned viscosity is a value measured by using a B-type viscometer at 25° C. and a rotation number of 60 rpm.

Furthermore, in a lithium ion secondary battery, the electrode active material may contain a conductivity-imparting material and a reinforcing material. As the conductivity-imparting material, conductive carbons such as acetylene black, Ketjen black, carbon black, graphite, vapor grown carbon fibers and carbon nanotubes can be used. Carbon powders such as graphite, fibers and foils of various metals, and the like may be exemplified. As the reinforcing material, various inorganic or organic fillers in a spherical, plate-like, rod-like or fibrous form can be used. By using the conductivity-imparting material, the electrical contact between the electrode active materials can be improved, and thus the discharge rate characteristic can be improved in the case when the electrode active materials are used in a lithium ion secondary battery. The use amount of the conductivity-imparting material is preferably 0 to 20 parts by weight, more preferably 1 to 10 parts by weight, with respect to 100 parts by weight of the electrode active material.

Although the electrode active material layer may be present alone, it is generally present in a form attached to a current collector. The electrode active material layer can be formed by attaching a mixed slurry containing the electrode active material and a dispersion medium to the current collector.

When the binder for an active material layer is incorporated in the electrode active material layer, the dispersion medium may be one that dissolves the binder or disperse the binder in particulate forms, and a dispersion medium that dissolves the binder is preferable. When the dispersion medium that dissolves the binder for an active material layer is used, the binder for an active material layer is adsorbed on the surface, and thus the dispersion of the electrode active material and the like is stabilized.

The mixed slurry contains a dispersion medium to allow the dispersion of the electrode active material, the binder for an active material layer and the conductivity-imparting material. It is preferable to use a dispersion medium that can dissolve the binder for an active material layer since the dispersibilities of the electrode active material and conductivity-imparting material are excellent. It is presumed that, by using the binder for an active material layer in the form of a solution in the dispersion medium, the binder for an active material layer is adsorbed on the surface of the electrode active material and the like to thereby stabilize the dispersion by the volume effect thereof.

Examples of the dispersion medium used in the mixed slurry may include those similar to the dispersion media used in the above-mentioned heat-resistant layer. These dispersion media can be used alone or by mixing two or more kinds, by suitably selecting from the viewpoints of drying velocity and circumstances. Among these, non-aqueous solvents are preferably used in the present invention from the viewpoint of the electrode swelling property in water.

The mixed slurry can contain additives that express various functions such as a thickening agent. As the thickening agent, polymers that are soluble in the dispersion medium used for the mixed slurry are used. Specifically, a hydrogenated product of an acrylonitrile-butadiene copolymer and the like are used.

Furthermore, in order to improve the stability and lifetime of the battery, trifluoropropylene carbonate, vinylene carbonate, cathecol carbonate, 1,6-dioxaspiro[4,4]nonane-2,7-dione, 12-crown-4-ether and the like can be used in the mixed slurry besides the above-mentioned components. Furthermore, these may be used by incorporating in the electrolyte solution mentioned below.

The amount of the organic solvent in the mixed slurry is adjusted prior to use so as to give a suitable viscosity for application, depending on the kinds of the electrode active material, binder for an active material layer and the like. Specifically, the concentration of the solid content as a combination of the electrode active material, binder for an active material layer and other additives in the mixed slurry is adjusted so as to be an amount of, preferably 30 to 90% by weight, more preferably 40 to 80% by weight.

The mixed slurry is obtained by mixing the electrode active material, and the binder for an active material layer, conductivity-imparting material, other additives and dispersion medium, which are added as necessary, by using a mixing device. The mixing can be conducted by feeding the above-mentioned respective components to the mixing device at once, and mixing the components. In the case when the electrode active material, binder for an active material layer, conductivity-imparting material and thickening agent are used as the constitutional components of the mixed slurry, it is preferable to mix the conductivity-imparting material and thickening agent in the dispersion medium to disperse the conductivity-imparting material in microparticulate forms, and then adding the binder for an active material layer and electrode active material and further mixing the components, since the dispersibility of the mixed slurry is improved. As the mixing device, those mentioned above can be used, and it is preferable to use a ball mill since the aggregation of the conductivity-imparting material and electrode active material can be suppressed.

The particle size of the mixed slurry is preferably 35 μm or less, further preferably 25 μm or less, from the viewpoint of obtaining a homogeneous electrode in which the conductivity-imparting material is dispersed at a high dispersibility.

(Current Collector)

Although the current collector is not specifically limited as long as it is a material having electroconductivity and electrochemical durability, metal materials such as iron, copper, aluminum, nickel, stainless steel, titanium, tantalum, gold and platinum are preferable from the viewpoint that they have heat resistance. Among these, aluminum is specifically preferable for a positive electrode of a nonaqueous electrolyte lithium ion secondary battery, and copper is specifically preferable for a negative electrode. Although the shape of the current collector is not specifically limited, a sheet-like form with a thickness of about 0.001 to 0.5 mm is preferable. It is preferable to subject the current collector to a surface roughing treatment in advance prior to use so as to enhance the adhesion to the electrode active material layer. Examples of the method for the surface roughing may include a mechanical polishing method, a electrolytic polishing method, a chemical polishing method and the like. In the mechanical polishing method, a polishing cloth paper on which polisher particles are fixed, a grinding stone, an emery wheel, a wire brush having steel wires, and the like are used. Furthermore, in order to enhance the adhesion to the electrode active material and the conductivity, an intermediate layer may be formed on the surface of the current collector.

The method for producing the electrode active material layer may be any method including binding the electrode active material layer in a laminar form to at least one surface, preferably both surfaces of the current collector. For example, the mixed slurry is applied onto the current collector and dried, and then subjected to a heat treatment at 120° C. or more for 1 hour or more to thereby form the electrode active material layer. The method for applying the mixed slurry onto the current collector is not specifically limited, and a similar method to the method for applying the slurry for a heat-resistant layer can be used.

Subsequently, it is preferable to conduct a pressurizing treatment by using a mold press, a roll press or the like to thereby decrease the porosity of the mixed agent in the electrode. The preferable range of the porosity is 5 to 15%, more preferably 7 to 13%. When the porosity is too high, the charge efficiency and discharge efficiency are deteriorated. In the case when the porosity is too low, problems that a high volume capacity is difficult to be obtained, and that the mixed agent is easily peeled off and thus defects easily occur, are caused. Furthermore, in the case when a curable polymer is used, it is preferable to cure the polymer.

The thickness of the electrode active material layer is generally 5 to 300 μm, preferably 10 to 250 μm, in both the positive electrode and negative electrode.

(Electrolyte Solution)

As the electrolyte solution, an organic electrolyte solution formed by dissolving a support electrolyte in an organic solvent is used. As the support electrolyte, a lithium salt is used. Examples of the lithium salt may include, but are not specifically limited to, LiPF₆, LiAsF₆, LiBF₄, LiSbF₆, LiAlCl₄, LiClO₄, CF₃SO₃Li, C₄F₉SO₃L₁, CF₃COOLi, (CF₃CO)₂NLi, (CF₃SO₂)₂NLi, (C₂F₅SO₂)NLi and the like. Among these, LiPF₆, LiClO₄ and CF₃SO₃Li, which easily dissolve in an organic solvent and show a high dissociation degree, are preferable. These may be used by combining two or more kinds. The higher the dissociation degree of the support electrolyte used is, the higher the lithium ion conductivity is. Therefore, the lithium ion conductivity can be adjusted by the kind of the support electrolyte.

Although the organic solvent used for the electrolyte solution is not specifically limited as long as it can dissolve the support electrolyte, carbonates such as dimethyl carbonate (DMC), ethylene carbonate (EC), diethyl carbonate (DEC), propylene carbonate (PC), butylene carbonate (BC) and methylethyl carbonate (MEC); esters such as γ-butyrolactone and methyl formate; ethers such as 1,2-dimethoxyethane and tetrahydrofuran; sulfur-containing compounds such as sulfolane and dimethylsulfoxide; are preferably used. Alternatively, a mixed liquid of these organic solvents may also be used. Among these, carbonates are preferable since they have a high dielectric constant and a broad stable potential region. The lower the viscosity of the organic solvent used is, the higher the lithium ion conductivity is. Therefore, the lithium ion conductivity can be adjusted by the kind of the organic solvent.

The concentration of the support electrolyte in the electrolyte solution is generally 1 to 30% by weight, preferably 5 to 20% by weight. Furthermore, the support electrolyte is generally used at a concentration of 0.5 to 2.5 mol/L depending on the kind of the support electrolyte. When the concentration of the support electrolyte is too low or too high, the ion conductivity tends to decrease. The lower the concentration of the electrolyte solution used is, the higher the swelling degree of the polymer particles is. Therefore, the lithium ion conductivity can be adjusted by the concentration of the electrolyte solution.

(Method for Producing Lithium Ion Secondary Battery)

Examples of the specific method for producing a lithium ion secondary battery may include a method including obtaining a laminate including a positive electrode and a negative electrode that are superposed through the separator for a secondary battery of the present invention, putting the laminate into a battery container by winding, folding or the like of the laminate according to the shape of the battery, pouring an electrolyte solution into the battery container, and sealing the opening.

In obtaining the laminate, it is preferable to subject the laminate to heat press. The heat press is a method for simultaneously conducting heating and press. The press is conducted by using a roll press machine using metal rolls, elastic rolls and the like, a flat plate press machine or the like. Examples of the system for the press may include batch-type press, continuous roll press and the like, and continuous roll press is preferable since the producibility is enhanced. Although the temperature for the heat press is not specifically limited as long as the structures of the electrodes that constitute the laminate and of the separator for a secondary battery are not broken, it is preferably 60 to 110° C., more preferably 70 to 105° C., specifically preferably 80 to 100° C.

The pressure for the heat press is generally 0.1 to 10 MPa, preferably 0.3 to 5 MPa, more preferably 0.5 to 3 MPa, from the viewpoint that the electrodes and the separator for a secondary battery are tightly attached while maintaining the porosity of the separator for a secondary battery. Furthermore, the time for conducting the heat press is generally 2 to 60 seconds, preferably 5 to 40 seconds, more preferably 8 to 20 seconds, from the viewpoint that the electrode active material layers and the separator for a secondary battery can be tightly attached, and thus high producibility is ensured.

Where necessary, an expand metal, a fuse, an over-current prevention element such as a PTC element, a lead plate and the like can be put into the battery container to thereby prevent increase of the pressure in the battery and overcharging and overdischarging. The shape of the battery may be any of a coin type, a button type, a sheet type, a cylindrical type, a square type, a planular type and the like.

According to the method for producing a slurry for a heat-resistant layer for a lithium ion secondary battery according to this exemplary embodiment, a slurry containing a water content and an unreacted monomer in decreased amounts can be efficiently obtained. Furthermore, since the slurry for a heat-resistant layer according to this exemplary embodiment is difficult to cause bubbling and has fine coating property, a homogeneous heat-resistant layer having a predetermined thickness is easily formed. In addition, pinholes are difficult to be formed on the heat-resistant layer even during high-speed application, and thus an improved yield ratio can be expected.

Furthermore, the slurry for a heat-resistant layer obtained by the method for producing a slurry for a heat-resistant layer for a lithium ion secondary battery according to this exemplary embodiment is excellent in dispersibility. Specifically, the amount of the excessively large particles in the non-conductive microparticles is decreased, and thus the bindability to the polymer is improved. Therefore, the detachment of the non-conductive microparticles can be prevented even in the case when an electrode having a heat-resistant layer formed by using the slurry for a heat-resistant layer according to this exemplary embodiment, and a separator are wound or slit.

In the above-mentioned exemplary embodiment, the step of obtaining the mixed solution can be conducted by using the binder composition production device 2 shown in FIG. 1. Specifically, NMP is charged in the substitution tank 4 by the NMP introduction line 10, and the NMP is adjusted to 30 to 70° C. by the heating jacket 6. Furthermore, a mixed solution may be obtained by introducing the polymer aqueous dispersion into the substitution tank 4 by the polymer aqueous dispersion-introduction line 8 under stirring by the stirring blade 3.

### EXAMPLES

Hereinafter the present invention will be specifically explained with showing Examples. However, the present invention is not limited to the Examples listed below, and may be arbitrarily modified and carried out within a scope that does not deviate from the scope of the claims of the present invention and equivalent scopes thereof.

In the following explanation, unless otherwise mentioned, the “%” and “part(s)” that indicate amounts are based on weights. Furthermore, unless otherwise mentioned, the operations explained below were conducted under conditions of ordinary temperature and ordinary pressure. The evaluations in Examples and Comparative Examples were conducted as follows.

(1) Measurement of Amount of Water Content

The amounts of the water contents in the binder compositions obtained in Examples and Comparative Examples were each measured by using the Karl-Fischer method (the water content vaporization method according to JIS K-0068 (2001), vaporization temperature: 200° C.) using a coulometric titration moisture meter. The measured amount of water content was evaluated according to the following criteria and shown in Table 1. The smaller the amount of the water content is, the more difficult the bubbling when the composition is formed into a slurry is, and the more difficult the formation of pinholes is.

A: less than 1,000 ppm
B: 1,000 ppm or more and less than 5,000 ppm
C: 5,000 ppm or more and less than 10,000 ppm
D: 10,000 ppm or more

(2) Measurement of Amount of Unreacted Monomer

The amounts of the unreacted monomers in the binder compositions obtained in Examples and Comparative Examples were each measured by using gas chromatography (column: capillary column HP-1 manufactured by Agilent Technologies, column temperature: 250° C., detector: FID). The measured amount of the unreacted monomer was evaluated according to the following criteria and shown in Table 1.

A: less than 50 ppm
B: 50 ppm or more and less than 300 ppm
C: 300 ppm or more and less than 1,000 ppm
D: 1,000 ppm or more

(3) Coating Property (Bubbling)

The slurries for a heat-resistant layer prepared in Examples and Comparative Examples were each applied onto a metal foil by a bar coater so that the thickness after drying became 4 μm, and dried for 20 minutes in an oven at 120° C. The obtained coating was cut into a size of 30 cm×30 cm, and the number of pinholes having a diameter of 0.1 mm or more was measured by visual observation with a magnifying glass of 20 magnifications. The number of the measured pinholes was evaluated according to the following criteria and shown in Table 1.

A small number of the pinholes indicates an excellent coating property. Furthermore, a slurry that is difficult to cause bubbling and has fine coating property is easily formed into a homogeneous heat-resistant layer having a predetermined thickness. In addition, pinholes are difficult to be formed on the heat-resistant layer even during high-speed application, and thus an improved yield ratio can be expected.

A: 1 pinhole or less
B: 2 or more and less than 6 pinholes
C: 6 or more and less than 10 pinholes
D: 10 or more pinholes

(4) Dispersibility of Slurry for Heat-Resistant Layer

Using a laser diffraction particle size distribution analyzer (SALD-2000, manufactured by Shimadzu Corporation), the volume average particle diameters D50 of the non-conductive microparticles of the slurries for a heat-resistant layer obtained in Examples and Comparative Examples were obtained. The volume average particle diameters D50 were evaluated according to the following criteria and shown in Table 1. The dispersibility of the slurry for a heat-resistant layer can be determined by the volume average particle diameter D50, and a volume average particle diameter D50 of the non-conductive microparticles in the slurry for a heat-resistant layer closer to the primary particle diameter of the non-conductive microparticles indicates more excellent dispersibility.

Furthermore, by using the slurry for a heat-resistant layer having excellent dispersibility, the amount of the excessively large particles in the non-conductive microparticles is decreased, and thus the bindability to the polymer is improved. Therefore, even in the case when an electrode having a heat-resistant layer, and a separator are wound or slit, the detachment of the non-conductive microparticles can be prevented.

A: The volume average particle diameter D50 of the non-conductive microparticles in the slurry for a heat-resistant layer is less than 1.2 times of the primary particle size of the non-conductive microparticles.
B: The volume average particle diameter D50 of the non-conductive microparticles in the slurry for a heat-resistant layer is 1.2 times or more and less than 1.4 times of the primary particle size of the non-conductive microparticles.
C: The volume average particle diameter D50 of the non-conductive microparticles in the slurry for a heat-resistant layer is 1.4 times or more and less than 1.6 times of the primary particle size of the non-conductive microparticles.
D: The volume average particle diameter D50 of the non-conductive microparticles in the slurry for a heat-resistant layer is 1.6 times or more and less than 1.8 times of the primary particle size of the non-conductive microparticles.
E: The volume average particle diameter D50 of the non-conductive microparticles in the slurry for a heat-resistant layer is 1.8 times or more of the primary particle size of the non-conductive microparticles.

(5) Loss Rate of NMP

In the production of the binder compositions of Examples and Comparative Examples, the loss rates of NMP was each calculated from the amount of the liquid distilled into the receiver 24 until the amount of the unreacted monomer in the binder composition became 300 ppm or less and the water amount became 5,000 ppm or less (distilled liquid amount). A smaller value shows a lower loss rate of NMP.

Loss rate of NMP [%]=(distilled liquid amount−amount of aqueous dispersion liquid)/amount of charged NMP×100

In Comparative Examples, the distillation was further continued after the cumulative distilled liquid amount became 128 parts by weight, and the loss rate of NMP was calculated from the data of the distilled liquid amount at the stage when the amount of the unreacted monomer reached 300 ppm or less and the water content reached 5,000 ppm or less.

The calculated loss rate of NMP was evaluated according to the following criteria and shown in Table 1.

A: less than 10%
B: 10% or more and less than 30%
C: 30% or more and less than 50%
D: 50% or more

### Example 1

### Production of Polymer Aqueous Dispersion

70 parts of ion-exchanged water, 0.15 parts of sodium lauryl sulfate as an emulsifier (manufactured by Kao Chemicals, product name: “EMAL 2F”) and 0.5 parts of ammonium persulfate were respectively fed to a reactor equipped with a stirrer, the gas phase part was substituted with a nitrogen gas, and the temperature was raised to 60° C. Meanwhile, 50 parts of ion-exchanged water, 0.5 parts of sodium dodecylbenzene sulfonate, and 94.8 parts of butyl acrylate, 2 parts of acrylonitrile, 2 parts of methacrylic acid, 0.6 parts of 2-acrylamide-2-methylpropanesulfonic acid and 0.6 parts of allylglycidyl ether as polymerizable monomers, and 0.15 parts of CHELEST 400G were mixed in a separate container to give a monomer mixture. This monomer mixture was continuously added to the reactor over 4 hours to effect polymerization. During the addition, the reaction was conducted at 60° C. After the completion of the addition, stirring was conducted at 70° C. for further 3 hours to complete the reaction to thereby give a polymer aqueous dispersion. The polymerization conversion rate obtained from the solid content concentration was 98%.

<Production of Mixed Solution>

1,300 parts of NMP was charged in the substitution tank 4 of the binder composition production device 2 (see FIG. 1) with respect to 100 parts of the polymer, and heated to 50° C. 100 parts of the above-mentioned polymer (polymer aqueous dispersion: 222 parts) was then added under stirring to give a mixed solution. The amount of the unreacted monomer at this time was 1,200 ppm or more and the amount of the water content was 8.7%.

<Production of Binder Composition>

A binder composition was produced by conducting distillation by using the binder composition production device 2 including the distillation column 12 having a number of theoretical stages of 5 (see FIG. 1). The pressure in the substitution tank 4 containing the above-mentioned mixed solution was reduced to 200 torr by the compressor 28, and the substitution tank 4 was heated by the heating jacket 6 so that the internal temperature of the substitution tank 4 became 70° C. The pressure was gradually reduced with observing the condition of bubbling, total reflux was conducted at 70 torr, a steady state was confirmed after 1 hour, and the reflux liquid was extracted at a reflux ratio R=2. Thereafter the pressure was decreased by the compressor 28 so that the internal temperature became 70° C. with observing the bubbling in the substitution tank 4, and the extracted liquid (distilled liquid) was distilled into the receiver 24 while the unreacted monomer and water were separated from NMP in the distillation column 12. At the timepoint when the distilled liquid amount reached 105 to 110 parts, 0.6 parts of ethanol was added to the substitution tank 4 as a substance that can be azeotropically distilled with water (hereinafter also referred to as “azeotropic solvent”). After the addition, distillation was continuously conducted, and the distillation was completed at the stage when 128 parts (1.05 times of the amount of the aqueous dispersion charged) of the distilled liquid amount in an accumulated amount had been distilled, to thereby give a binder composition. At this time, the solid content concentration was 7.2%, the amount of the unreacted monomer in the binder composition was 20 ppm, and the amount of the water content was 500 ppm.

<Production of Slurry for Heat-Resistant Layer for Lithium Secondary Battery>

The non-conductive microparticles (alumina, volume average particle diameter: 0.5 μm) and the binder composition were mixed so as to give a content rate of 100:3 (solid content-corresponding ratio). Furthermore, NMP was added so that the solid content concentration became 40%, and the mixture was pre-mixed by a disper blade. The mixture was then dispersed by using a cone mill type dispersion machine (IKA MKO manufactured by IKA) at a circumferential velocity of 40 m/s to give a slurry for a heat-resistant layer.

### Example 2

A mixed solution was prepared in a similar manner to that of Example 1, except that 900 parts of NMP was charged with respect to 100 parts of the polymer in the production of the mixed solution. Thereafter a binder composition and a slurry for a heat-resistant layer for a lithium ion secondary battery were produced in similar manners to that of Example 1.

### Example 3

A binder composition was produced in a similar manner to that of Example 1, except that the distillation was conducted by using the binder composition production device 2 including the distillation column 12 having a number of theoretical stages of 2 in the production of the binder composition. Thereafter a slurry for a heat-resistant layer for a lithium ion secondary battery was produced in a similar manner to that of Example 1.

### Example 4

A binder composition was produced in a similar manner to that of Example 1, except that the reflux liquid was extracted at a reflux ratio R=1 in the production of the binder composition. Thereafter a slurry for a heat-resistant layer for a lithium ion secondary battery was produced in a similar manner to that of Example 1.

### Example 5

In the production of the binder composition, the pressure in the substitution tank 4 containing the mixed solution was reduced to 200 torr, and the mixed solution in the substitution tank 4 was heated to 90° C. by the heating jacket 6. Furthermore, a binder composition was produced in a similar manner to that of Example 1, except that the pressure was decreased with observing the bubbling in the substitution tank 4 so that the internal temperature became 90° C. Thereafter a slurry for a heat-resistant layer for a lithium ion secondary battery was produced in a similar manner to that of Example 1.

### Example 6

In the production of the binder composition, the pressure in the substitution tank 4 with the mixed solution therein was reduced to 200 torr, and the mixed solution in the substitution tank 4 was heated to 55° C. by the heating jacket 6. Furthermore, a binder composition was produced in a similar manner to that of Example 1, except that the pressure was decreased with observing the bubbling in the substitution tank 4 so that the internal temperature became 55° C. Thereafter a slurry for a heat-resistant layer for a lithium ion secondary battery was produced in a similar manner to that of Example 1.

### Example 7

A slurry for a heat-resistant layer for a lithium ion secondary battery was produced in a similar manner to that of Example 1, except that the circumferential velocity of the cone mill type dispersion machine was set to 60 m/s in the production of the slurry for a heat-resistant layer for a lithium secondary battery.

### Example 8

A binder was produced in a similar manner to that of Example 1, except that 1 part of acetone was used instead of ethanol as an azeotropic solvent in the production of the binder composition. Thereafter a slurry for a heat-resistant layer for a lithium ion secondary battery was produced in a similar manner to that of Example 1.

### Example 9

A binder was produced in a similar manner to that of Example 1, except that an azeotropic solvent was not used in the production of the binder composition. Thereafter a slurry for a heat-resistant layer for a lithium ion secondary battery was produced in a similar manner to that of Example 1.

### Comparative Example 1

A binder composition was produced in a similar manner to that of Example 1, except that single distillation was conducted without installing a distillation column in the production of the binder composition. Thereafter a slurry for a heat-resistant layer for a lithium ion secondary battery was produced in a similar manner to that of Example 1.

### Comparative Example 2

A binder composition was produced in a similar manner to that of Example 1, except that the decreasing of the pressure using the compressor 28 was not conducted in the production of the binder composition. Thereafter a slurry for a heat-resistant layer for a lithium ion secondary battery was produced in a similar manner to that of Example 1.

TABLE 1

| | | Example 1 | | Example 2 | |
|---|---|---|---|---|---|
| Step of producing | Polymerization conversion rate | 98% | | 98% | |
| polymer aqueous | Kind of polymer | Acrylate | | Acrylate | |
| dispersion | | | | | |
| Step of obtaining | NMP and polymer aqueous dispersion | Mixed | | Mixed | |
| mixed solution | NMP/polymer (weight ratio) | 13/1 | | 9/1 | |
| Step of obtaining | Distillation column was used | Distillation column | | Distillation column | |
| binder | | was used | | was used | |
| composition | Number of theoretical stages of | 5 | | 5 | |
| | distillation column | | | | |
| | Reflux ratio | 2 | | 2 | |
| | Internal temperature of substitution | 70 | | 70 | |
| | tank 4 (° C.) | | | | |
| | Pressure in substitution tank 4 under | 50 torr-4 torr | | 50 torr-4 torr | |
| | reduced pressure when residual amount | | | | |
| | of water content is 5% or less | | | | |
| | Pressure in substitution tank 4 under | 200 torr-50 torr | | 200 torr-50 torr | |
| | reduced pressure at initial stage of | | | | |
| | initiation of distillation | | | | |
| | Kind of substance that can be | Ethanol | | Ethanol | |
| | azeotropically distilled with water | | | | |
| | Addition amount of substance that can | 0.6 | | 0.6 | |
| | be azeotropically distilled with water | | | | |
| | (parts) | | | | |
| | Timing of addition | Added at timepoint | | Added at timepoint | |
| | | when distillation | | when distillation | |
| | | amount reached 90% | | amount reached 90% | |
| | | of amount of water | | of amount of water | |
| | | content in polymer | | content in polymer | |
| | | aqueous dispersion | | aqueous dispersion | |
| | Amount of unreacted monomer in | 20 | ppm | 20 | ppm |
| | binder composition | | | | |
| | Amount of water content in binder | 500 | ppm | 500 | ppm |
| | composition | | | | |
| Step of obtaining | Non-conductive microparticles | Alumina | | Alumina | |
| slurry | Non-conductive microparticles/polymer | 100/3 | | 100/3 | |
| | Circumferential velocity of dispersion | 40 | m/s | 40 | m/s |
| | machine | | | | |
| | Solid content concentration of slurry | 40% | | 40% | |
| | for heat-resistant layer | | | | |
| | Film thickness of heat-resistant layer | 4 | μm | 4 | μm |
| | Drying temperature | 110° | C. | 110° | C. |
| Evaluated items | (1) Amount of water content | A | | A | |
| | (2) Amount of unreacted monomer | A | | A | |
| | (3) Coating property (bubbling) | A | | A | |
| | (4) Dispersibility of slurry for heat- | A | | A | |
| | resistant layer | | | | |
| | (5) Loss rate of NMP | A | | A | |
| | | Example 3 | | Example 4 | |
| Step of producing | Polymerization conversion rate | 98% | | 98% | |
| polymer aqueous | Kind of polymer | Acrylate | | Acrylate | |
| dispersion | | | | | |
| Step of obtaining | NMP and polymer aqueous dispersion | Mixed | | Mixed | |
| mixed solution | NMP/polymer (weight ratio) | 13/1 | | 13/1 | |
| Step of obtaining | Distillation column was used | Distillation column | | Distillation column | |
| binder | | was used | | was used | |
| composition | Number of theoretical stages of | 2 | | 5 | |
| | distillation column | | | | |
| | Reflux ratio | 2 | | 1 | |
| | Internal temperature of substitution | 70 | | 70 | |
| | tank 4 (° C.) | | | | |
| | Pressure in substitution tank 4 under | 50 torr-4 torr | | 50 torr-4 torr | |
| | reduced pressure when residual amount | | | | |
| | of water content is 5% or less | | | | |
| | Pressure in substitution tank 4 under | 200 torr-50 torr | | 200 torr-50 torr | |
| | reduced pressure at initial stage of | | | | |
| | initiation of distillation | | | | |
| | Kind of substance that can be | Ethanol | | Ethanol | |
| | azeotropically distilled with water | | | | |
| | Addition amount of substance that can | 0.6 | | 0.6 | |
| | be azeotropically distilled with water | | | | |
| | (parts) | | | | |
| | Timing of addition | Added at timepoint | | Added at timepoint | |
| | | when distillation | | when distillation | |
| | | amount reached 90% | | amount reached 90% | |
| | | of amount of water | | of amount of water | |
| | | content in polymer | | content in polymer | |
| | | aqueous dispersion | | aqueous dispersion | |
| | Amount of unreacted monomer in | 50 | ppm | 50 | ppm |
| | binder composition | | | | |
| | Amount of water content in binder | 1000 | ppm | 1000 | ppm |
| | composition | | | | |
| Step of obtaining | Non-conductive microparticles | Alumina | | Alumina | |
| slurry | Non-conductive microparticles/polymer | 100/3 | | 100/3 | |
| | Circumferential velocity of dispersion | 40 | m/s | 40 | m/s |
| | machine | | | | |
| | Solid content concentration of slurry | 40% | | 40% | |
| | for heat-resistant layer | | | | |
| | Film thickness of heat-resistant layer | 4 | μm | 4 | μm |
| | Drying temperature | 110° | C. | 110° | C. |
| Evaluated items | (1) Amount of water content | B | | B | |
| | (2) Amount of unreacted monomer | B | | B | |
| | (3) Coating property (bubbling) | A | | A | |
| | (4) Dispersibility of slurry for heat- | A | | A | |
| | resistant layer | | | | |
| | (5) Loss rate of NMP | A | | A | |
| | | Example 5 | | Example 6 | |
| Step of producing | Polymerization conversion rate | 98% | | 98% | |
| polymer aqueous | Kind of polymer | Acrylate | | Acrylate | |
| dispersion | | | | | |
| Step of obtaining | NMP and polymer aqueous dispersion | Mixed | | Mixed | |
| mixed solution | NMP/polymer (weight ratio) | 13/1 | | 13/1 | |
| Step of obtaining | Distillation column was used | Distillation column | | Distillation column | |
| binder | | was used | | was used | |
| composition | Number of theoretical stages of | 5 | | 5 | |
| | distillation column | | | | |
| | Reflux ratio | 2 | | 2 | |
| | Internal temperature of substitution | 90 | | 55 | |
| | tank 4 (° C.) | | | | |
| | Pressure in substitution tank 4 under | 100 torr-7 torr | | 40 torr-2 torr | |
| | reduced pressure when residual amount | | | | |
| | of water content is 5% or less | | | | |
| | Pressure in substitution tank 4 under | 200 torr-100 torr | | 200 torr-40 torr | |
| | reduced pressure at initial stage of | | | | |
| | initiation of distillation | | | | |
| | Kind of substance that can be | Ethanol | | Ethanol | |
| | azeotropically distilled with water | | | | |
| | Addition amount of substance that can | 0.6 | | 0.6 | |
| | be azeotropically distilled with water | | | | |
| | (parts) | | | | |
| | Timing of addition | Added at timepoint | | Added at timepoint | |
| | | when distillation | | when distillation | |
| | | amount reached 90% | | amount reached 90% | |
| | | of amount of water | | of amount of water | |
| | | content in polymer | | content in polymer | |
| | | aqueous dispersion | | aqueous dispersion | |
| | Amount of unreacted monomer in | 50 | ppm | 50 | ppm |
| | binder composition | | | | |
| | Amount of water content in binder | 500 | ppm | 500 | ppm |
| | composition | | | | |
| Step of obtaining | Non-conductive microparticles | Alumina | | Alumina | |
| slurry | Non-conductive microparticles/polymer | 100/3 | | 100/3 | |
| | Circumferential velocity of dispersion | 40 | m/s | 40 | m/s |
| | machine | | | | |
| | Solid content concentration of slurry | 40% | | 40% | |
| | for heat-resistant layer | | | | |
| | Film thickness of heat-resistant layer | 4 | μm | 4 | μm |
| | Drying temperature | 110° | C. | 110° | C. |
| Evaluated items | (1) Amount of water content | A | | A | |
| | (2) Amount of unreacted monomer | B | | B | |
| | (3) Coating property (bubbling) | A | | A | |
| | (4) Dispersibility of slurry for heat- | A | | A | |
| | resistant layer | | | | |
| | (5) Loss rate of NMP | A | | A | |
| | | Example 7 | | Example 8 | |
| Step of producing | Polymerization conversion rate | 98% | | 98% | |
| polymer aqueous | Kind of polymer | Acrylate | | Acrylate | |
| dispersion | | | | | |
| Step of obtaining | NMP and polymer aqueous dispersion | Mixed | | Mixed | |
| mixed solution | NMP/polymer (weight ratio) | 13/1 | | 13/1 | |
| Step of obtaining | Distillation column was used | Distillation column | | Distillation column | |
| binder | | was used | | was used | |
| composition | Number of theoretical stages of | 5 | | 5 | |
| | distillation column | | | | |
| | Reflux ratio | 2 | | 2 | |
| | Internal temperature of substitution | 70 | | 70 | |
| | tank 4 (° C.) | | | | |
| | Pressure in substitution tank 4 under | 50 torr-4 torr | | 50 torr-4 torr | |
| | reduced pressure when residual amount | | | | |
| | of water content is 5% or less | | | | |
| | Pressure in substitution tank 4 under | 200 torr-50 torr | | 200 torr-50 torr | |
| | reduced pressure at initial stage of | | | | |
| | initiation of distillation | | | | |
| | Kind of substance that can be | Ethanol | | Acetone | |
| | azeotropically distilled with water | | | | |
| | Addition amount of substance that can | 0.6 | | 1 | |
| | be azeotropically distilled with water | | | | |
| | (parts) | | | | |
| | Timing of addition | Added at timepoint | | Added at timepoint | |
| | | when distillation | | when distillation | |
| | | amount reached 90% | | amount reached 90% | |
| | | of amount of water | | of amount of water | |
| | | content in polymer | | content in polymer | |
| | | aqueous dispersion | | aqueous dispersion | |
| | Amount of unreacted monomer in | 20 | ppm | 50 | ppm |
| | binder composition | | | | |
| | Amount of water content in binder | 500 | ppm | 500 | ppm |
| | composition | | | | |
| Step of obtaining | Non-conductive microparticles | Alumina | | Alumina | |
| slurry | Non-conductive microparticles/polymer | 100/3 | | 100/3 | |
| | Circumferential velocity of dispersion | 60 | m/s | 40 | m/s |
| | machine | | | | |
| | Solid content concentration of slurry | 40% | | 40% | |
| | for heat-resistant layer | | | | |
| | Film thickness of heat-resistant layer | 4 | μm | 4 | μm |
| | Drying temperature | 110° | C. | 110° | C. |
| Evaluated items | (1) Amount of water content | A | | A | |
| | (2) Amount of unreacted monomer | A | | B | |
| | (3) Coating property (bubbling) | C | | A | |
| | (4) Dispersibility of slurry for heat- | B | | A | |
| | resistant layer | | | | |
| | (5) Loss rate of NMP | A | | A | |
| | | | | Comparative | |
| | | Example 9 | | Example 1 | |
| Step of producing | Polymerization conversion rate | 98% | | 98% | |
| polymer aqueous | Kind of polymer | Acrylate | | Acrylate | |
| dispersion | | | | | |
| Step of obtaining | NMP and polymer aqueous dispersion | Mixed | | Mixed | |
| mixed solution | NMP/polymer (weight ratio) | 13/1 | | 13/1 | |
| Step of obtaining | Distillation column was used | Distillation column | | Single distillation | |
| binder | | was used | | | |
| composition | Number of theoretical stages of | 5 | | — | |
| | distillation column | | | | |
| | Reflux ratio | 2 | | — | |
| | Internal temperature of substitution | 70 | | 70 | |
| | tank 4 (° C.) | | | | |
| | Pressure in substitution tank 4 under | 50 torr-4 torr | | 50 torr-4 torr | |
| | reduced pressure when residual amount | | | | |
| | of water content is 5% or less | | | | |
| | Pressure in substitution tank 4 under | 200 torr-50 torr | | 200 torr-50 torr | |
| | reduced pressure at initial stage of | | | | |
| | initiation of distillation | | | | |
| | Kind of substance that can be | Azeotropic solvent is | | Ethanol | |
| | azeotropically distilled with water | not added. | | | |
| | Addition amount of substance that can | — | | 0.6 | |
| | be azeotropically distilled with water | | | | |
| | (parts) | | | | |
| | Timing of addition | — | | Added at timepoint | |
| | | | | when distillation | |
| | | | | amount reached 90% | |
| | | | | of amount of water | |
| | | | | content in polymer | |
| | | | | aqueous dispersion | |
| | Amount of unreacted monomer in | 20 | ppm | 500 | ppm |
| | binder composition | | | | |
| | Amount of water content in binder | 1000 | ppm | 5000 | ppm |
| | composition | | | | |
| Step of obtaining | Non-conductive microparticles | Alumina | | Alumina | |
| slurry | Non-conductive microparticles/polymer | 100/3 | | 100/3 | |
| | Circumferential velocity of dispersion | 40 | m/s | 40 | m/s |
| | machine | | | | |
| | Solid content concentration of slurry | 40% | | 40% | |
| | for heat-resistant layer | | | | |
| | Film thickness of heat-resistant layer | 4 | μm | 4 | μm |
| | Drying temperature | 110° | C. | 110° | C. |

| | | | |
|---|---|---|---|
| Evaluated items | (1) Amount of water content | B | C |
| | (2) Amount of unreacted monomer | A | C |
| | (3) Coating property (bubbling) | A | C |
| | (4) Dispersibility of slurry for heat- | A | A |
| | resistant layer | | |
| | (5) Loss rate of NMP | A | C |

| | | Comparative |
|---|---|---|
| | | Example 2 |
| Step of producing | Polymerization conversion rate | 98% |
| polymer aqueous | Kind of polymer | Acrylate |
| dispersion | | |
| Step of obtaining | NMP and polymer aqueous dispersion | Mixed |
| mixed solution | NMP/polymer (weight ratio) | 13/1 |
| Step of obtaining | Distillation column was used | Distillation column |
| binder | | was used |
| composition | Number of theoretical stages of | 5 |
| | distillation column | |
| | Reflux ratio | 2 |
| | Internal temperature of substitution | 100 |
| | tank 4 (° C.) | |
| | Pressure in substitution tank 4 under | Pressure is not |
| | reduced pressure when residual amount | reduced. (Heated at |
| | of water content is 5% or less | ordinary pressure) |
| | Pressure in substitution tank 4 under | Pressure is not |
| | reduced pressure at initial stage of | reduced. (Heated at |
| | initiation of distillation | ordinary pressure) |
| | Kind of substance that can be | Ethanol |
| | azeotropically distilled with water | |
| | Addition amount of substance that can | 0.6 |
| | be azeotropically distilled with water | |
| | (parts) | |
| | Timing of addition | Added at timepoint |
| | | when distillation |
| | | amount reached 90% |
| | | of amount of water |
| | | content in polymer |
| | | aqueous dispersion |

| | | |
|---|---|---|
| Amount of unreacted monomer in | 1000 | ppm |
| binder composition | | |

| | | |
|---|---|---|
| | Amount of water content in binder | 5% |
| | composition | |
| Step of obtaining | Non-conductive microparticles | Alumina |
| slurry | Non-conductive microparticles/polymer | 100/3 |

| Circumferential velocity of dispersion | 40 | m/s |
|---|---|---|
| machine | | |
| Solid content concentration of slurry | 40% | |
| for heat-resistant layer | | |
| Film thickness of heat-resistant layer | 4 | μm |
| Drying temperature | 110° | C. |

| | | |
|---|---|---|
| Evaluated items | (1) Amount of water content | D |
| | (2) Amount of unreacted monomer | D |
| | (3) Coating property (bubbling) | D |
| | (4) Dispersibility of slurry for heat- | C |
| | resistant layer | |
| | (5) Loss rate of NMP | C |

As shown in Table 1, in the method for producing a slurry for a heat-resistant layer for a lithium ion secondary battery including a step of producing a polymer aqueous dispersion by polymerizing a monomer in an aqueous medium to give a polymer aqueous dispersion containing a polymer with a polymerization conversion rate of 90 to 100%, a step of obtaining a mixed solution by mixing N-methylpyrrolidone and the polymer aqueous dispersion, a step of obtaining a binder composition by removing an unreacted monomer and the aqueous medium from the mixed solution, and a step of obtaining a slurry by dispersing non-conductive microparticles in the binder composition, when the aqueous medium and the unreacted monomer were removed by using a distillation column under a reduced pressure so that the binder composition contains the unreacted monomer in an amount of 300 ppm or less and a water content in an amount of 5,000 ppm or less in the step of obtaining the binder composition, the coating property and dispersibility were fine, and the loss rate of NMP was small.

1. A method for producing a slurry for a heat-resistant layer for a lithium ion secondary battery, comprising:
a step of producing a polymer aqueous dispersion by polymerizing a monomer in an aqueous medium to give a polymer aqueous dispersion containing a polymer with a polymerization conversion rate of 90 to 100%,
a step of obtaining a mixed solution by mixing N-methylpyrrolidone and the polymer aqueous dispersion,
a step of obtaining a binder composition by removing an unreacted monomer and the aqueous medium from the mixed solution, and
a step of obtaining a slurry by dispersing non-conductive microparticles in the binder composition,
wherein the step of obtaining the binder composition comprises removing the aqueous medium and the unreacted monomer by using a distillation column under a reduced pressure so that the binder composition contains the unreacted monomer in an amount of 300 ppm or less and a water content in an amount of 5,000 ppm or less.

2. The method for producing a slurry for a heat-resistant layer for a lithium ion secondary battery according to claim 1, wherein the slurry having a solid content concentration of 10 to 50% is obtained by adding N-methylpyrrolidone, in at least one of (i) during the step of obtaining the binder composition, (ii) between the step of obtaining the binder composition and the step of obtaining the slurry, (iii) during the step of obtaining the slurry, and (iv) after the step of obtaining the slurry.

3. The method for producing a slurry for a heat-resistant layer for a lithium ion secondary battery according to claim 1, wherein the step of obtaining the binder composition comprises a step of adding a substance that can be azeotropically distilled with water to the mixed solution.

4. The method for producing a slurry for a heat-resistant layer for a lithium ion secondary battery according to claim 1, wherein the step of obtaining the slurry comprises dispersing the non-conductive microparticles by using a dispersing machine having a circumferential velocity of 4 to 60 m/s.

5. A method for producing an electrode for a lithium ion secondary battery, comprising a step of applying the slurry for a heat-resistant layer for a lithium ion secondary battery according to claim 1, and a step of drying the slurry.

6. The method for producing a slurry for a heat-resistant layer for a lithium ion secondary battery according to claim 2, wherein the step of obtaining the binder composition comprises a step of adding a substance that can be azeotropically distilled with water to the mixed solution.

7. The method for producing a slurry for a heat-resistant layer for a lithium ion secondary battery according to claim 2, wherein the step of obtaining the slurry comprises dispersing the non-conductive microparticles by using a dispersing machine having a circumferential velocity of 4 to 60 m/s.

8. The method for producing a slurry for a heat-resistant layer for a lithium ion secondary battery according to claim 3, wherein the step of obtaining the slurry comprises dispersing the non-conductive microparticles by using a dispersing machine having a circumferential velocity of 4 to 60 m/s.

9. A method for producing an electrode for a lithium ion secondary battery, comprising a step of applying the slurry for a heat-resistant layer for a lithium ion secondary battery according to claim 2, and a step of drying the slurry.

10. A method for producing an electrode for a lithium ion secondary battery, comprising a step of applying the slurry for a heat-resistant layer for a lithium ion secondary battery according to claim 3, and a step of drying the slurry.

11. A method for producing an electrode for a lithium ion secondary battery, comprising a step of applying the slurry for a heat-resistant layer for a lithium ion secondary battery according to claim 4, and a step of drying the slurry.
